(19) United States
(12) Patent Application Publication
(10) Pub. No.: US 2011/0290135 A1
(43) Pub. Date: Dec. 1, 2011

(54) METHOD OF FURTHER INSERTING A PARTIALLY INSERTED LEADING AND/OR TRAILING EDGE OF A PRINTING PLATE INTO RESPECTIVE LOCK-UP SLOTS IN A PLATE CYLINDER OF A PRINTING PRESS

(75) Inventors: Tony Hollings, Lancashire (GB); Bob Goodman, Blackpool (GB)

(73) Assignee: Goss Graphic Systems Limited, Preston, Lancashire (GB)

(21) Appl. No.: 12/919,730

(22) PCT Filed: Feb. 27, 2009
(86) PCT No.: PCT/EP2009/052367

§ 371 Date: Aug. 17, 2011

(30) Foreign Application Priority Data
Feb. 27, 2008 (GB) 0803577.6

(51) Int. Cl. B41F 27/12; B41L 1/02

(52) U.S. Cl. 101/477; 101/485

(57) ABSTRACT

A method of further inserting a partially inserted leading and/or trailing edge of a printing plate into respective lock-up slots in a plate cylinder of a printing press to allow register slots in said edges to engage with lateral pins or a register mechanism in said lock-up slots is disclosed. The method comprises the step of positioning a pushing element relative to the curved surface of the plate cylinder, on which a printing plate is disposed with its leading and/or trailing edges partially inserted into their respective lock-up slots, such that said pushing element will engage and push a raised portion of said printing plate, adjacent to said partially inserted leading and/or trailing edge, down onto the surface of the plate cylinder and the leading and/or trailing edge further into their respective lock-up slots, as said plate cylinder rotates.

The present invention relates to a method of further inserting a partially inserted leading and/or trailing edge of a printing plate into respective lock-up slots in a plate cylinder of a printing press to allow register slots, with chamfered lead-in, in said edges to engage with lateral pins, with chamfered lead-in, or a register mechanism in said lock-up slots. More specifically, it relates to a method for further inserting the leading and/or trailing edge of a printing plate into respective lock-up slots, at least one of the leading and/or trailing edges having been partially inserted using a semi or fully automatic plate loading process. In one particular embodiment, the invention relates to a method for further inserting a trailing edge of a printing plate into its lock-up slot, the leading edge having been manually inserted by the operator prior to partial insertion of the trailing edge by a semi-automatic plate loading process.

### BACKGROUND

A web offset printing press comprises a number of printing units. Each unit is designed to print matter onto a continuous web of paper as it travels through the print unit. The printed web emerging from each print unit come together in a folding unit which orientates, folds and cuts each web to produce the finished article such as a newspaper or magazine. Each unit contains at least one pair of cylinder groups or print couples comprising a rotatably mounted plate cylinder, to which one or more printing plates are attached for printing and, a rotatably mounted blanket cylinder. The printing unit may incorporate a shaft less drive system in which each cylinder group is driven by its own drive motor that directly drives one of the cylinders of a group via a belt or gear drive and the other cylinder of that group is mechanically coupled to the driven cylinder. An inking system associated with each print couple is operable to feed ink onto the printing plates attached to the plate cylinder as the plate cylinder rotates. As the cylindrical surfaces of the plate and blanket cylinder are in rolling contact, an inked image is transferred from the printing plates onto the blanket cylinder and from the blanket cylinder onto the medium to be printed.

In large scale high volume presses used, for example, in the production of newspapers, multi-colour printing is achieved by providing each print unit with a number of printing couples arranged in pairs which are mounted vertically above one another in a stack so that the paper web travels in a vertically upward direction between each pair of print couples. A unit having four print couple pairs, i.e. eight print couples, is able to print up to four colours on each side of the paper web and is often referred to as a “four-high” unit.

When a press is prepared for a print run, at least one printing plate carrying the image to be printed must be mounted to the plate cylinder of each print couple. Generally, each plate cylinder includes at least one recess or lock-up slot extending longitudinally along the surface of the plate cylinder into which is received the leading and trailing edge of a printing plate. A mechanism located in the recess engages the leading and trailing edges of an inserted printing plate and firmly holds the printing plate in position during a print run. The number of printing plates that must be attached to the plate cylinder of each print couple depends on the width of the press and whether the plate cylinder carries one or two printing plates around its circumference, i.e. whether it is a “one around” or “two around” plate cylinder. For example, in a double width one-around press, the plate cylinder may carry four printing plates across its width and one printing plate extending circumferentially around its cylindrical surface. Therefore, there could be as many as eight printing plates in a single printing couple pair and thirty-two printing plates in a four high printing unit all of which must be replaced before a new print run can be initiated. When the plate cylinder is of the “two-around” type, the number of printing plates is doubled accordingly. Therefore, it will be appreciated that even in the production of just one newspaper issue, a very large number of printing plates will be required.

It is of the utmost importance to ensure that all the printing plates attached to one plate cylinder are located in very precise circumferential and lateral registration with respect to each other. It will also be appreciated that as ink of a different colour is applied to the print medium as it passes through each print couple pair of a print unit, it is also important that the printing plates are in alignment with the printing plates attached to each of the other plate cylinders of the press as any misalignment of a printing plate will result in mis-registration or misalignment of the different coloured inks applied to the print medium which will reduce the quality of the final print.

To enable accurate location of the printing plates, care must be taken to install each printing plate accurately onto the plate cylinder. A commonly known method of aligning a printing plate on a plate cylinder and to make sure that it is located in an “in-register” position is to provide the leading and trailing edges of each plate with a number of register slots that locate on respective register pins in the leading and trailing edge lock-up slots in which the leading and trailing edges of the printing plate are received, when attached to a plate cylinder. The position of the slots and pins are predetermined so that, when the pins have been located in the slots, the printing plate is in the correct position and the press operator can be confident that the printing plate will be positioned correctly in relation to other printing plates.

In a conventional printing machine, the press operator loads both the leading and trailing edges of each printing plate onto the plate cylinders manually so that they are located in their predetermined in-register positions. Although this generally results in accurate positioning of the printing plates, it will be appreciated that this activity is very labour intensive and time consuming especially when a large number of printing plates need to be replaced. It also means that the press, or at least individual print units, are rendered inoperable for an extended period of time and this has a significantly detrimental affect on the overall productivity of the press. Furthermore, it increases the possibility for human error, especially when a very large number of plates must be replaced several times during the production of a newspaper and in a very short period of time.

In an attempt to reduce the setting-up time and minimise human error, attempts have been made to automate or partially automate the plate loading process in which printing plates are automatically fed onto, and accurately located on, the plate cylinder by a printing plate feeding mechanism attached to the printing unit. In such systems, the press operator either accurately positions the printing plates in printing plate holders fixed to the printing press adjacent to each of the plate cylinders of the press or, the position of the printing plates is established by position sensors or similar devices whilst the plates are fed onto the plate cylinder.

It is also known from the Applicant's previous application No. EP1879746 to provide a semi-automatic printing plate loading system in which a press operator manually engages the leading edge of each printing plate in its lock-up slot and ensures that the printing plate lead edge register slot is in alignment with the lead edge slot register pin. Once manual insertion of the lead edge has been completed, the plate cylinder is rotated and a pressure nip applies pressure to the printing plates to ensure that the plates are wrapped closely around the plate cylinder, as the plate cylinder rotates and to press the lead edge of the plates fully home into the lead edge lock-up slot. This pressure nip can be provided by the plate to blanket cylinder nip when on impression. Alternatively, or additionally, it can be provided by a separate pressure roller which may be selectively positioned in or out of rolling engagement with the surface of the plate cylinder.

Once the printing plate has been wrapped around the plate cylinder, the trailing edge of the printing plate is then at least partially inserted into its lock-up slot by an automated plate loading apparatus and the intention is that the trailing edge will be pushed fully home into its lock-up slot as it passes through the pressure nip as the plate cylinder continues to rotate in the same direction.

Although the above-described semi-automatic plate loading system simplifies the loading process and improves accuracy and speed in plate positioning, it has been found that accurate manual location of the plate lead edge in its lock-up slot is no guarantee that the trailing edge register slots will automatically align with their corresponding register pins in the trailing edge lock-up slot when the trailing edge is inserted into the lock up slot by the plate loading apparatus. If there is any misalignment, the register pins and trailing edge register slots will not engage when the printing plate trailing edge is partially inserted by the plate loading apparatus. Consequently, when the trailing edge passes through the pressure nip during continued rotation of the plate cylinder, the pressure against the misaligned trailing edge will simply damage the edge of the slot in the printing plate without correction of the misalignment.

Although it has been found that the pressure nip can correct misalignment between the register pins and the slots in the trailing edge of the printing plate if the mouth of the register slot is provided with chamfered or otherwise profiled edges which guide the register pin into the slot as pressure is applied to the plate by the nip, the misalignment must be very slight for it to be successfully corrected in this way.

### SUMMARY OF THE INVENTION

The present invention seeks to provide a method of further inserting a partially inserted leading and/or trailing edge of a printing plate into respective lock-up slots in a plate cylinder of a printing press to allow register slots in said edges to engage with lateral pins or a register mechanism in said lock-up slots, and which substantially overcomes or alleviates the problems discussed above.

According to the invention, there is provided a method of further inserting a partially inserted leading and/or trailing edge of a printing plate into respective lock-up slots in a plate cylinder of a printing press to allow register slots in said edges to engage with lateral pins or a register mechanism in said lock-up slots, the method comprising the step of positioning a pushing element relative to the curved surface of the plate cylinder, on which a printing plate is disposed with its leading and/or trailing edges partially inserted into their respective lock-up slots, such that said pushing element will engage and push a raised portion of said printing plate, adjacent to said partially inserted leading and/or trailing edge, down onto the surface of the plate cylinder and the leading and/or trailing edge further into their respective lock-up slots, as said plate cylinder rotates.

If the leading and/or trailing edges have not been fully inserted into their lock-up slots, the leading and/or trailing edges and the printing plate adjacent to said edges will sit proud or slightly raised-up off the curved surface of the plate rather than lie flat against it. It is this proud region of the printing plate that the pushing element is intended to engage and push down against the plate, thereby further inserting the leading and/or trailing edges into their respective lock-up slots. The pushing element is positioned relative to the curved surface such that the printing plate is allowed to “float” or move laterally when the pushing element engages and pushes the raised portion of the printing plate down onto the surface of the cylinder. Ideally, the pushing element is spaced from the surface of the printing plate lying against the surface of the plate cylinder so that it does not contact the printing plate apart from in its raised region, although it is envisaged that it could sweep across the plate generally applying little or no pressure to it, apart from when it reaches said raised regions of the plate. Because the pushing element does not force the plate down against the surface of the plate cylinder, the plate can move laterally to adjust for small misalignments and the register pins and slots in the leading and/or trailing edges are more likely to engage easily when the pushing element passes over said raised region of the plate. This is not possible when the plate is effectively pinned to the surface of the plate cylinder by the force applied to it by the plate and blanket cylinder nip or pressure roller nip, as is conventional.

As indicated in the previous paragraph, it is preferable that the step of positioning the pushing element relative to the curved surface of the plate cylinder comprises the step of positioning it spaced from the surface of the plate cylinder by a distance which is just greater than the thickness of a printing plate so that the pushing element only engages said raised portion of said printing plate as the plate cylinder rotates. This ensures that the printing plate has the ability to move laterally by a sufficient distance to enable the register slots to align with their corresponding register pins. This action is aided by the provision of a small chamfered lead-in edge on both register pin and register slot.

In one embodiment, the method includes the step of at least partially inserting a leading edge of a printing plate into a leading edge lock-up slot in a plate cylinder and operating a plate loading apparatus to at least partially insert a trailing edge of said printing plate into a trailing edge lock-up slot in the plate cylinder prior to positioning the pushing element relative to the curved surface of the plate cylinder.

The step of at least partially inserting a leading edge of a printing plate into a leading edge lock-up slot may comprise manually inserting said leading edge. Alternatively, the method may include the step of operating said plate loading apparatus to at least partially insert a leading edge of a printing plate into a leading edge lock-up slot.

In one embodiment, the step of at least partially inserting said trailing edge includes the step of rotating the plate cylinder in a first direction into a position in which the plate loading apparatus is positioned substantially above the trailing edge lock-up slot, after inserting the leading edge into its leading edge lock up slot.

The step of at least partially inserting said trailing edge further includes the step of rotating the plate cylinder in a second direction, opposite to the first direction, prior to positioning a pushing element relative to the curved surface of the plate cylinder.

The plate loading apparatus may comprise a plate loading head including printing plate gripping means and the pusher element and the method may include the steps of:
(a) lowering the plate loading head towards the plate cylinder such that the printing plate gripping means contacts the surface of the printing plate;
(b) activating the printing plate gripping means to grip the printing plates;
(c) raising the plate loading head;
(d) operating the pusher element to deflect the trailing edge of the printing plate toward the plate cylinder;

(e) deactivating the gripping means so that the trailing edge of the printing plate slides at least partially into the trailing edge lock-up slot.

In one embodiment, the method includes the step of continuing to rotate the plate cylinder, after positioning a pushing element relative to the curved surface of the plate cylinder, such that the trailing edge of the printing plate passes through a pressure nip between a plate and blanket cylinder and/or through a pressure nip between a pressure roller and the plate cylinder, to push the trailing edge of the printing plate fully into its lock up slot after being further inserted into its lock up slot by the pushing element.

### BRIEF DESCRIPTION OF THE DRAWINGS

Embodiments of the invention, will now be described, by way of example only, and with reference to FIGS. 3A to 3D of the accompanying drawings, in which:

FIG. 1 is a schematic side sectional view through a portion of a print unit of a rotary off-set printing press in which can be seen a plate cylinder, part of a blanket cylinder of one print couple and a conventional plate loading apparatus including a plate loading head;

FIG. 2A to 2D is a sequence of drawings to illustrate how the conventional apparatus may be used to carry out an initial series of steps so as to partially load a printing plate onto a plate cylinder of a printing press; and

FIG. 3A to 3D is a sequence of drawings to illustrate further steps that form part of the method according to the present invention and which complete the plate loading process so that the trailing edge of a printing plate is fully inserted into its corresponding lock-up slot without any misalignment or damage to the register slot.

### DETAILED DESCRIPTION

In the following description of a preferred embodiment, reference is made to a semi-automatic plate loading process in which the lead edge is manually inserted into its lock-up slot and the trailing edge is at least partially inserted into its lock-up slot by a semi-automatic plate loading process, the method of the invention being used to further insert the trailing edge. However, it will be appreciated that the method of the invention can be applied to both leading and trailing edges irrespective of whether one or both of them have been inserted manually or by using a semi or fully automated plate loading apparatus.

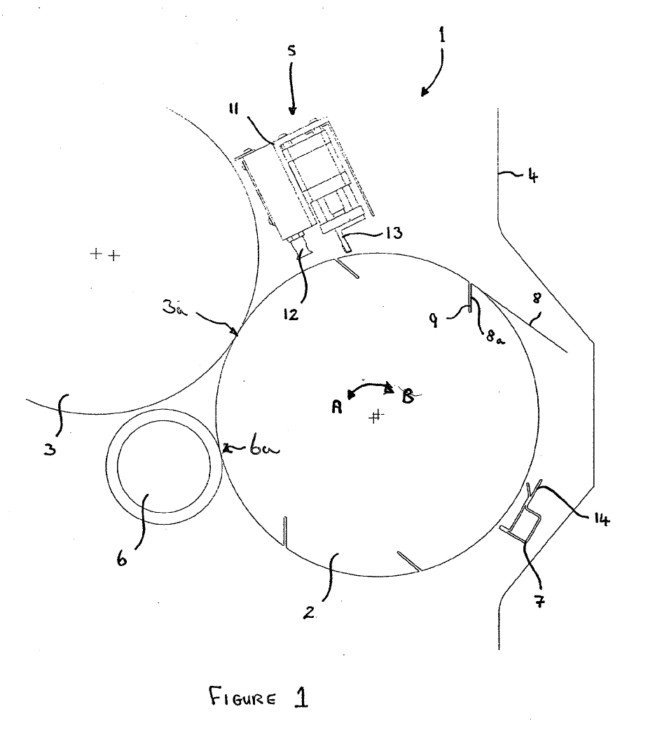

Referring now to the drawings, there is shown in FIG. 1 a side-sectional view of a portion of printing unit 1 of a rotary web offset printing press according to an embodiment of the invention showing the plate and blanket cylinders 2,3 of one cylinder group or print couple mounted within a frame 4. As already explained above, each print unit 1 of the press includes multiple cylinder groups. As each cylinder group is the same as that shown in FIG. 1, it is sufficient for understanding of the invention for only one such group to be illustrated and described in detail.

The plate loading apparatus comprises a plate loading head 5 and a pressure roller 6 disposed around a plate cylinder 2. In addition to loading printing plates 8, the plate loading head 5 may also be used to unload printing plates 8 from the plate cylinder 2 and a plate leading edge extraction or “stripper” bar 7 is also provided to assist in plate removal. However, as the present invention is concerned with printing plate loading, no further reference will be made to the function of the plate loading apparatus 5 or stripper bar 7 in a plate unloading sequence here, although reference may be made to the Applicant's earlier application identified above for further details.

The plate loading head 5 can be moved using air cylinders (not shown) between a raised position in which it is spaced away from the plate cylinder 2 when no plate loading operation is being performed and the printing unit 1 is in use and, a lowered position for carrying out a plate loading sequence on the plate cylinder 2. It will be appreciated that, for a complete 4 high printing tower, 8 sets of assemblies are required, one for each print couple.

The plate loading head 5 includes an elongate support frame 11 that extends substantially across the entire width of the plate cylinder 2. An array of plate gripping elements 12 are mounted to and depend from the support frame 11 so as to face the plate cylinder 2 and, when activated, are operable to engage the surface of a set of printing plates 8 to enable the printing plates 8 to be manipulated by the plate loading head 5. The plate loading head 5 also includes a pusher element 13 depending from the support frame 11 adjacent to and in the same direction as the plate gripping elements 12. The pusher element 13 is independently movable relative to the support frame 11 and to the plate gripping elements 12 in a direction towards and away from the plate cylinder 2 for reasons that will become apparent.

The pressure roller 6 is separate to the plate loading head 5 and also extends across the length of the plate cylinder 2. The pressure roller 6 may also be moved into and out of engagement with the plate cylinder 2 and rotates together with the plate cylinder 2 when in engagement therewith. The pressure roller 6 or the plate cylinder 2 to blanket cylinder 3 impression nip ensures that the leading and trailing edges 8a,8b of any printing plates 8 located on the plate cylinder 2 are pushed fully home into their lock-up slots 9,10, but only after the register slots (not shown) in the trailing edge 8b of the printing plate 8 has engaged with their corresponding register pins (not shown) in the trailing edge lock-up slot 10 following partial insertion of the trailing edge 8b of the printing plate 8 into the trailing edge lock up slot 10 by the plate loading head 5. The method by which the register slots and pins are aligned prior to the trailing edge 8b passing through the pressure nip to push the trailing edge 8b of the printing plate 8 fully home will be described in more detail below, following a description of the procedures involved in the loading of one or more printing plates 8 onto the plate cylinder 2.

The print unit 1, or at least the pair of print couples for which the printing plates are to be loaded, are taken off-line. The plate cylinder 2 is then indexed forward by rotating it in the direction of arrow “A”, as shown in FIG. 1, so that the lock-up slot 9 for the leading edge 8a of the printing plate 8 is accessible to the operator. This position is generally indicated by the position of the plate cylinder 2 in FIG. 1. The lead edge 8a of the printing plates are now manually inserted into their lock up slots 9 in the correct positions as guided by register pins in the leading edge lock-up slot 9 and corresponding register slots in the lead edge of the printing plate 8, as is conventional. Rotation of the plate cylinder 2 in the direction of arrow “A” is then continued to wrap the printing plates 8 around the plate cylinder 2 and so that the lead edge 8a and lock-up slot 9 passes beneath the plate loading head 5 and through the printing plate and blanket nip 3a and through the nip 6a formed by the pressure roller 6 which is in a lowered position so that it lies in contact with the surface of the plate cylinder 2. As the lead edge 8a passes through the printing and blanket cylinder nip 3a or pressure roller nip 6a, pressure is applied to the printing plate 8 to ensure that the lead edge 8a of the printing plate 8 is pushed fully “home” into its lead edge lock-up slot 9.

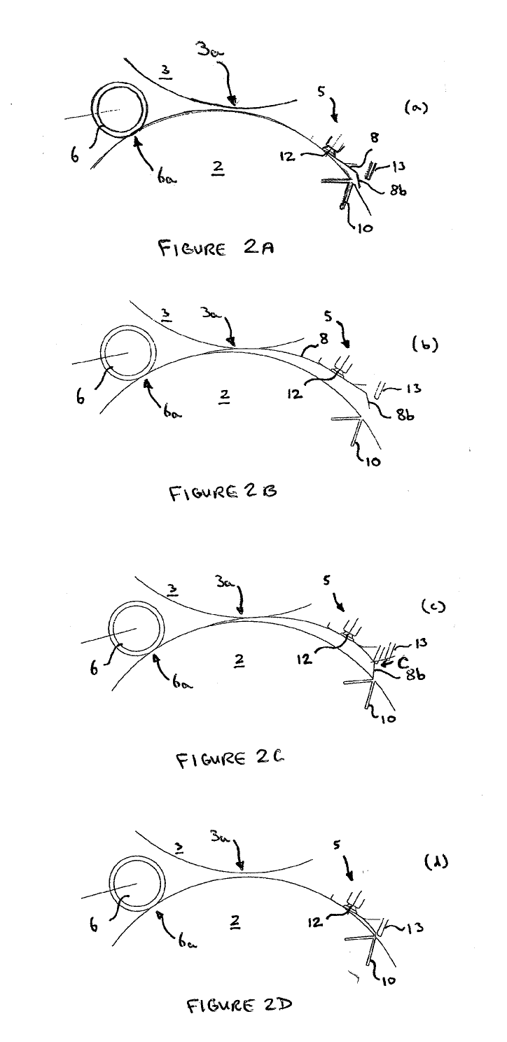

The plate cylinder 2 continues to rotate in the direction of arrow “A” until the trailing edge lock-up slot 10, to receive the trailing edge 8b of the printing plate 8, is positioned substantially below the trailing edge 8b of the printing plate 8 which has now been wrapped around the plate cylinder 2, as shown in FIG. 2a. Next, the plate loading head 5 is lowered so that the plate gripping elements 12 come into contact with the surface of the printing plate 8 adjacent to the trailing edge 8b, as also shown in FIG. 2a. The plate gripping elements 12 are then activated to grasp the printing plate 8 and the plate loading head 5 is raised so as to lift the trailing edge 8b of the printing plate 8 off the plate cylinder 2, as shown in FIG. 2b. The pusher element 13 is then activated so that it moves in the direction indicated by arrow “C” so as to deflect the trailing edge 8b of the printing plate 8 inwardly towards the plate cylinder 2, as shown in FIG. 2c, and the plate loading head 5 is then lowered again, and/or the plate gripping elements deactivated, so that the trailing edge 8b of the plate 8 at least partially drops into its lock-up slot 10, as shown in FIG. 2d. If the plate gripping elements are still active, they are now deactivated to release the printing plate 8.

If the register slots in the trailing edge 8b of the printing plate 8 are in close alignment with their corresponding register pins in the trailing edge lock-up slot 10, the trailing edge 8b of the printing plate 8 may drop into the lock-up slot 10 so that the pins and slots engage when inserted by the plate loading head 5 and the plate and blanket cylinder pressure nip 3a and/or pressure nip 6a will then just press the pins and slots into further registration and the trailing edge 8b fully home. However, invariably there is some misalignment between the register pins and trailing edge register slots, despite accurate manual insertion of the leading edge. This means that the trailing edge register slots and register pins do not immediately engage on insertion of the trailing edge 8b by the plate loading head 5 and the trailing edge 8b is left partially inserted by the plate loading head 5.

To prevent damage to the edge of the register slots in the trailing edge 8b caused when the partially inserted and misaligned trailing edge 8b passes through the plate and blanket cylinder pressure nip 3a and/or pressure nip 6a, a further sequence is carried out to ensure that the pins and slots are in registration prior to the trailing edge 8b passing through the plate and blanket cylinder nip 3a or the pressure nip 6a, as will now be explained.

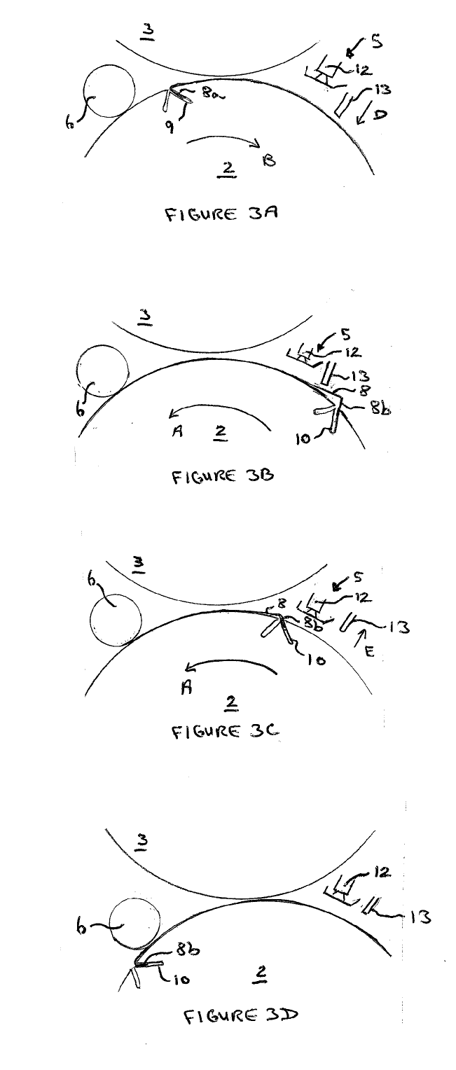

Firstly, the plate cylinder 2 is rotated back in the opposite direction (in the direction of arrow “B” in FIG. 1) to a position as shown generally by FIG. 3A. In this position, the printing plate 8 has passed back through the pressure nip 6a provided by the pressure roller 6 but has not passed back through the nip 3a provided between the plate and blanket cylinder 2,3. The extent to which the plate cylinder 2 may be rotated in the direction of arrow “B” may be varied, although it is preferable that the pressure applied by the plate and blanket cylinder nip 3a against the printing plate 2 is maintained to prevent the printing plate 8 from slipping out of the lead edge lock-up slot 9. Therefore, the plate cylinder 2 is not rotated in the direction of arrow B to a point beyond which the printing plate 8 is no longer received in the nip 3a between the plate and blanket cylinder 2, 3.

Once the position shown in FIG. 3A has been reached, the pusher element 13 is moved towards the plate cylinder 2 (in the direction of arrow D in FIG. 3A) so that it is spaced a small distance above its surface. This distance is at least slightly greater than the thickness of the printing plate 8. The lowered position of the pusher element 13 is maintained as the plate cylinder 2 is then again rotated in the direction of arrow “A”, as shown in FIG. 3B. During this rotation of the plate cylinder 2, the pusher element 13 contacts the surface of the printing plate 8 towards its trailing edge 8b, due to its proximity to the printing plate surface, and applies pressure evenly across the trailing edge of the plate 8 so as to push it further into the trailing edge lock-up slot 10. As the pusher element 13 is spaced from the surface of the plate cylinder 2, the printing plate 8 is able to move laterally or “float” in a direction across the plate cylinder 2 to enable the trailing edge register slots to align more easily with their corresponding lock-up slot register pins. This action is aided by the provision of a small chamfered lead-in edge on both register pin and register slot.

As the plate cylinder 2 rotates, in the direction of arrow B, the pusher element 13 slides across the surface of the printing plate 8 and so is formed from a material that will not damage the surface of the printing plate 8. For example, it could be made of nylon and/or be provided with a coating have a low coefficient of friction.

It will be appreciated that in the conventional method, in which the trailing edge is pushed into its lock-up slot by the plate and blanket cylinder nip 3a and/or the pressure roller nip 6a, directly after insertion of the trailing edge by the plate loading head 5, the printing plate 8 is not able to move laterally or float as the printing plate 8 is pressed into its lock-up slot because the pressure nip 6a or plate and blanket cylinder nip 3a hold the printing plate 8 firmly against the plate cylinder 2 substantially preventing any lateral movement.

As the pusher element 13 is spaced from the surface of the plate cylinder 2 by a distance greater than the thickness of the printing plate 8, the pusher element 13 cannot push the trailing edge 8b of the printing plate 8 fully home into its lock-up slot. However, the distance is sufficient to ensure that the register pins in the lock up slot and the register slots in the trailing edge are aligned and are at least in partial engagement.

Although the printing plate 8 is retained between the plate and blanket cylinder nip 3a during the aforementioned steps to prevent the lead edge 8a from slipping out of its lock-up slot 9, the distance between the nip 3a and the point at which the pusher element 13 passes over the trailing edge 8b is sufficient to allow for some lateral movement of the plate 8 so that registration can be achieved.

Once the pusher element 13 has passed over the trailing edge 8b of the printing plate 2 and the trailing edge 8b has been pushed further into the lock-up slot 10 to align the register pins with their corresponding slots, as shown in FIG. 3C, the rotation of the plate cylinder 2 in the direction of arrow A is continued so that the trailing edge 8b of the printing plate 8 passes through the plate and blanket cylinder pressure nip 3a and the pressure nip 6a so as to push the trailing edge 8b fully home into its lock up slot 10, as shown in FIG. 3D. As the pusher element 13 has already ensured that the register pins and register slots are aligned, the plate and blanket cylinder nip 3a and pressure nip 6a simply pushes the trailing edge 8b fully home, with no risk of further misalignment or damage to the register slots.

Many modifications and variations of the invention falling within the terms of the following claims will be apparent to those skilled in the art and the foregoing description should be regarded as a description of the preferred embodiments only.

What is claimed is:

1-10. (canceled)

11. A method of further inserting at least one of a partially inserted leading or trailing edge of a printing plate into respective leading or trailing edge lock-up slots in a plate cylinder of a printing press to allow register slots, with a chamfered lead-in, in the at least one of the leading or trailing edges to engage with lateral pins, with a chamfered lead-in, or a register mechanism in the lock-up slots, the method comprising:
positioning a pushing element relative to a curved surface of the plate cylinder, on which the printing plate is disposed with the at least one of the leading or trailing edges partially inserted into the respective lock-up slots, such that the pushing element will engage and push a raised portion of the printing plate, adjacent to the partially inserted at least one of the leading or trailing edges, down onto the curved surface of the plate cylinder and the at least one of the leading or trailing edges further into the respective lock-up slots, as the plate cylinder rotates.

12. The method according to claim 11 wherein the step of positioning the pushing element relative to the curved surface of the plate cylinder comprises the step of positioning the pushing element spaced from the curved surface of the plate cylinder by a distance which is just greater than the thickness of a printing plate so that the pushing element only engages the raised portion of the printing plate as the plate cylinder rotates.

13. The method according to claim 11 further comprising at least partially inserting the leading edge of the printing plate into the leading edge lock-up slot in the plate cylinder and operating a plate loading apparatus to at least partially insert the trailing edge of the printing plate into the trailing edge lock-up slot in the plate cylinder prior to positioning the pushing element relative to the curved surface of the plate cylinder.

14. The method according to claim 13 wherein the step of at least partially inserting the leading edge of a printing plate into the leading edge lock-up slot comprises manually inserting the leading edge.

15. The method according to claim 13 wherein the step of at least partially inserting the leading edge of the printing plate into the leading edge lock-up slot in the plate cylinder is performed by a plate loading apparatus.

16. The method according to claim 13 wherein the step of at least partially inserting the trailing edge includes rotating the plate cylinder in a first direction into a position in which the plate loading apparatus is positioned substantially above the trailing edge lock-up slot, after inserting the leading edge into the leading edge lock-up slot.

17. The method according to claim 16 wherein the step of at least partially inserting the trailing edge further includes rotating the plate cylinder in a second direction, opposite to the first direction, prior to positioning the pushing element relative to the curved surface of the plate cylinder.

18. The method according to claim 16 wherein the plate loading apparatus comprises a plate loading head including printing plate gripper and the pusher element and the step of at least partially inserting the trailing edge includes:
(a) lowering the plate loading head towards the plate cylinder such that the printing plate gripper contacts the surface of the printing plate;
(b) activating the printing plate gripper to grip the printing plate;
(c) raising the plate loading head;
(d) operating the pusher element to deflect the trailing edge of the printing plate toward the plate cylinder;
(e) deactivating the gripper so that the trailing edge of the printing plate slides at least partially into the trailing edge lock-up slot.

19. The method according to claim 11 further comprising continuing to rotate the plate cylinder, after positioning the pushing element relative to the curved surface of the plate cylinder, such that the trailing edge of the printing plate passes through at least one of a pressure nip between a plate and blanket cylinder or a pressure nip between a pressure roller and the plate cylinder, to push the trailing edge of the printing plate fully into the trailing edge lock-up slot after being further inserted into the trailing edge lock-up slot by the pushing element.
